(19) United States
(12) Patent Application Publication
(10) Pub. No.: US 2023/0182149 A1
(43) Pub. Date: Jun. 15, 2023

(54) ELECTROSTATIC PRECIPITATION AIR CLEANING SYSTEM

(71) Applicant: Air Quality Engineering, Inc., Brooklyn Park, MN (US)

(72) Inventors: Paul J. STANTON, Mendota Heights, MN (US); Patrick K. GORALCZYK, Mound, MN (US); Elena GERBER, Plymouth, MN (US)

(73) Assignee: Air Quality Engineering, Inc., Brooklyn Park, MN (US)

(21) Appl. No.: 17/924,252

(22) PCT Filed: May 12, 2020
(86) PCT No.: PCT/US2020/032452

§ 371 Date: Nov. 9, 2022

(51) Int. Cl. B03C 3/68; B03C 3/36

(52) U.S. Cl. CPC B03C 3/68; B03C 3/368

(57) ABSTRACT

An electrostatic precipitation air cleaning system for removing mist, smoke or particles from an air stream. The electrostatic precipitation air cleaning system includes an ionizer, a collector, and an exhaust fan configured to draw the air stream through the ionizer and the collector. The electrostatic precipitation air cleaning system includes a high voltage power supply that provides an ionizer voltage to the ionizer and at least a first collector voltage and a second collector voltage. The electrostatic precipitation air cleaning system includes an electrostatic precipitator controller coupled to or integrated with the high voltage power supply and operable to select one of the at least the first collector voltage and the second collector voltage to provide to the collector.

### FIELD OF TECHNOLOGY

The present application relates to an electrostatic precipitation air cleaning system for removing mist, smoke or particles from an air stream.

### BACKGROUND

Electrostatic precipitator systems are typically used with machine tools for collecting and removing smoke, mist and metal particle contaminants produced during operation of the machine tool. Electrostatic precipitator systems can be mounted in proximity to the machine tool such that the contaminants produced by the machine tool are directed through electrostatic precipitator cells within the electrostatic precipitator system. The machine tool coolant fluids generated during operation of the machine tool can be either water-soluble or oil-based. Electrostatic precipitator systems work well in applications where the machine tool coolant is oil-based. The collected oil mist contaminants are easily collected without issue. With water-soluble machine tool coolants, a nuisance arcing problem can occur because the collected mist is conductive and can arc and short out collectors within the electrostatic precipitator cells.

Electrostatic precipitator systems typically use a high voltage supply that delivers a voltage of 8,200 VDC to the ionizers and 4,150 VDC to the collectors during operation. While 4,150 VDC works well with collectors when oil-based coolants are used by the machine tool, a lower collector voltage is desired when water soluble coolants are used to avoid the arcing and shorting out of the collectors. Because it is difficult to switch high voltages, one approach that has been used is to use a voltage induced into the collector from the ionizer. When 8,200 VDC is supplied to the ionizer, the induced voltage from the ionizer to the collector is about 2,500 VDC which is effective when water soluble coolants are used. Because this voltage is induced or provided indirectly to the collector, it can be difficult to determine if a collector is experiencing problems such as arcing or shorting.

For these and other reasons, there is a need for the present invention.

### SUMMARY

According to an embodiment of an electrostatic precipitation air cleaning system for removing mist, smoke or particles from an air stream, the electrostatic precipitation air cleaning system includes an ionizer, a collector and an exhaust fan configured to draw the air stream through the ionizer and the collector. The electrostatic precipitation air cleaning system includes a high voltage power supply that provides an ionizer voltage to the ionizer and at least a first collector voltage and a second collector voltage. The electrostatic precipitation air cleaning system includes an electrostatic precipitator controller coupled to the high voltage power supply and operable to select one of the at least the first collector voltage and the second collector voltage to provide to the collector.

According to an embodiment of an electrostatic precipitation air cleaning system for removing water-soluble mist, smoke or particles or oil-based mist, smoke or particles from an air stream, the electrostatic precipitation air cleaning system includes a housing that includes a bottom input port and a top output port, an electrostatic precipitator cell mounted within the housing that includes an ionizer and a collector, and an exhaust fan mounted within the housing between the output port and the electrostatic precipitator cell and operable to draw the airstream through the electrostatic precipitator cell from the input port. The electrostatic precipitation air cleaning system includes a high voltage power supply that provides a DC ionizer voltage at a first output and a switchable DC collector voltage at a second output, and includes a collector voltage controller coupled to the high voltage power supply that is operable to set the switchable DC collector voltage at the second output to at least a first one of a plurality of DC collector voltages and a second one of a plurality of DC collector voltages.

According to an embodiment of an electrostatic precipitation air cleaning system for removing water-soluble mist, smoke or particles or oil-based mist, smoke or particles from an air stream, the electrostatic precipitation air cleaning system includes a rectangular housing that includes an airstream input port at a bottom of the housing and an airstream output grill at a top of the housing, a high voltage power supply that provides a DC ionizer voltage at a first output and a switchable DC collector voltage at a second output, one or more electrostatic precipitator cells mounted within the housing, where each electrostatic precipitator cell including an ionizer and a collector. The ionizer coupled to the first output and the collector is coupled to the second output. The electrostatic precipitation air cleaning system includes a collector indicator light coupled to the second output of the high voltage power supply. The collector indicator light changes from an illuminated state to a non-illuminated state or from the non-illuminated state to the illuminated state if the switchable DC collector voltage at the second output falls below a collector voltage threshold level. The electrostatic precipitation air cleaning system includes an exhaust fan driven by an electric motor and is mounted within the housing adjacent to the output grill. The exhaust fan is operable to draw the airstream through the one or more electrostatic precipitator cells from the input port.

Those skilled in the art will recognize additional features and advantages upon reading the following detailed description, and upon viewing the accompanying drawings.

### BRIEF DESCRIPTION OF THE DRAWINGS

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1a illustrates a top perspective view of an embodiment of an electrostatic precipitation air cleaning system;

FIG. 1b illustrates a bottom perspective view of the electrostatic precipitation air cleaning system illustrated in FIG. 1a;

FIG. 2 illustrates an embodiment of an electrical circuit diagram for an electrostatic precipitation air cleaning system;

FIG. 3 illustrates an embodiment of a diagram for a high voltage power supply for an electrostatic precipitation air cleaning system; and

FIG. 4 illustrates an embodiment of an optimal collector voltage range for collectors in an electrostatic precipitation air cleaning system.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

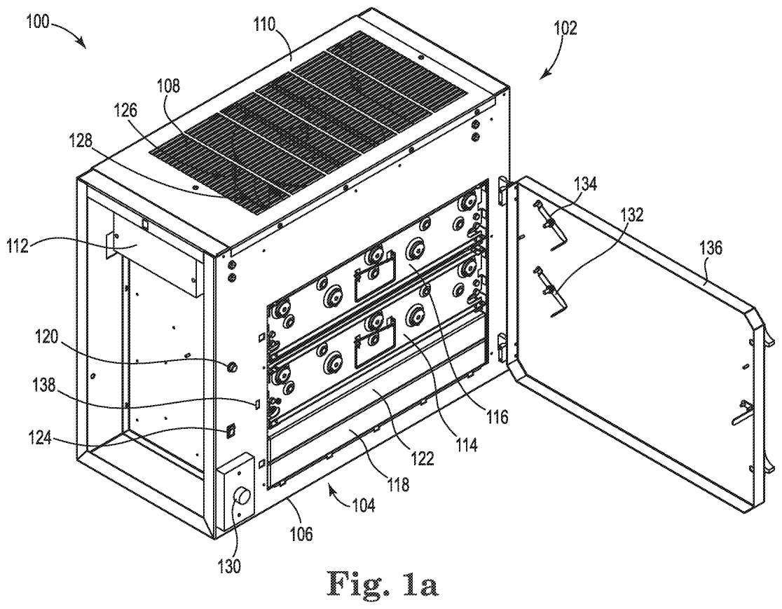

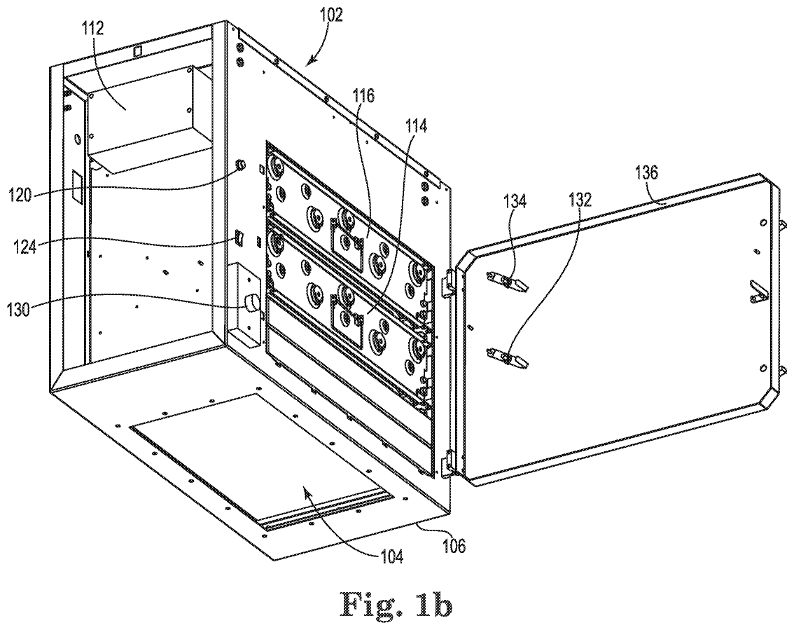

FIG. 1a illustrates a top perspective view of an embodiment of an electrostatic precipitation air cleaning system at 100. FIG. 1b illustrates a bottom perspective view of the electrostatic precipitation air cleaning system 100 illustrated in FIG. 1a. In the illustrated embodiments, electrostatic precipitation air cleaning system 100 removes water-soluble mist smoke or particles from an airstream, or removes oil-based mist smoke or particles from an airstream. In the embodiments described herein, electrostatic precipitation air cleaning system 100 is used for the source collection and removal of smoke, mist and metal particle contaminants produced from machine tool coolant fluids.

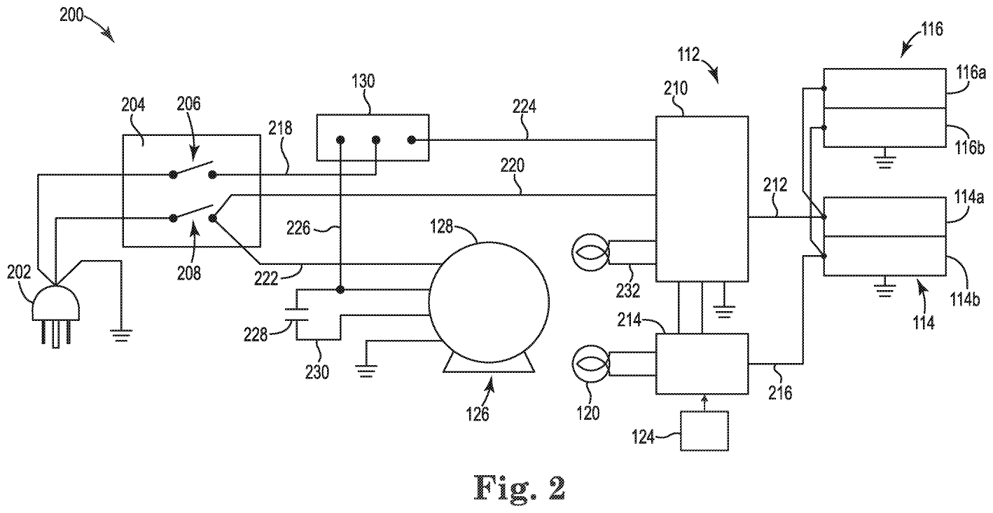

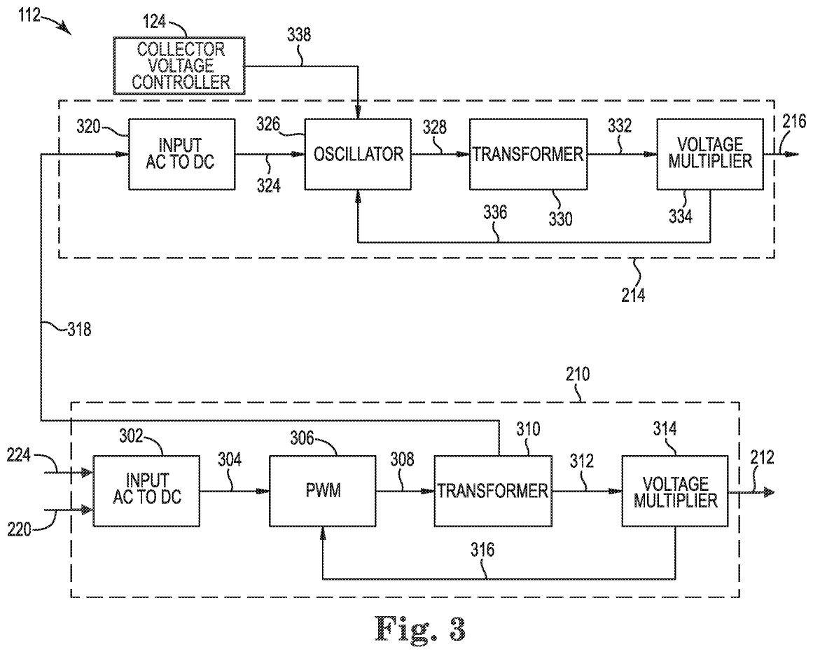

In the illustrated embodiment, electrostatic precipitation air cleaning system 100 has a rectangular housing 102 that includes an airstream input port 104 at a bottom 106 of the housing 102 and an airstream output port 108 or output grill 108 at a top 110 of the housing 102. A high voltage power supply 112 provides a DC ionizer voltage at a first output 212 and a switchable DC collector voltage at a second output 216 (see also, FIGS. 2-3). Two electrostatic precipitator cells 114 and 116 are mounted within housing 102. In other embodiments, one electrostatic precipitator cell or more than two electrostatic precipitator cells can be mounted within housing 102. In the illustrated embodiment, electrostatic precipitator cell 114 includes an ionizer 114a and a collector 114b. Electrostatic precipitator cell 116 includes an ionizer 116a and a collector 116b. Mechanical mist impingers 118 and 122 are mounted between input port 104 and electrostatic precipitator cell 114. Housing 102 also includes a collector indicator light 120. The collector indicator light 120 changes from an illuminated state to a non-illuminated state or from the non-illuminated state to the illuminated state if the switchable DC collector voltage at the second output 216 falls below a collector voltage threshold level. In one embodiment, the collector voltage threshold level is approximately equal to zero volts. In one embodiment, the collector voltage threshold level is reached when the high voltage power supply fails or shuts down.

In another embodiment, housing 102 includes an ionizer indicator light 232 coupled to first output 212 of high voltage power supply 112 that changes from an illuminated state to a non-illuminated state or from the non-illuminated state to the illuminated state if the DC ionizer voltage at the first output 212 falls below an ionizer voltage threshold level (see also, FIG. 2). In one embodiment, the collector voltage threshold level is approximately equal to zero volts. In one embodiment, the ionizer voltage threshold level is reached when the high voltage power supply fails or shuts down.

In another embodiment, the collector indicator light 120 changes from the illuminated state to the non-illuminated state or from the non-illuminated state to the illuminated state if the DC ionizer voltage at the first output 212 falls below an ionizer threshold voltage level or if the switchable DC collector voltage at the second output falls 216 below a collector voltage threshold level. In one embodiment, the ionizer threshold voltage level and the collector voltage threshold level are approximately equal to zero volts. In one embodiment, the ionizer threshold voltage level and the collector voltage threshold level are reached when the high voltage power supply fails or shuts down.

In the illustrated embodiment, a collector voltage controller 124 is coupled to the high voltage power supply 112 that is operable to set the switchable DC collector voltage at the second output 216 to a value that is greater than zero and less than the DC ionizer voltage (see also, FIGS. 2-3). In another embodiment, collector voltage controller 124 is integrated with high voltage power supply 112 such that collector voltage controller 124, first power supply circuit 210 and second power supply circuit 214 are incorporated into a single power supply or power supply circuit that provides both the ionizer voltage at first output 212 and one or more collector voltages at second output 216. In the embodiment illustrated in FIGS. 1a-1b, the collector voltage controller 124 is a collector switch 124 having a first switch state and a second switch state, the collector switch 124 operable to set the switchable DC collector voltage to a first one of the plurality of DC collector voltages when the collector switch is in the first switch state and set the switchable DC collector voltage to a second one of the plurality of DC collector voltages when the collector switch is in the second switch state. In the illustrated embodiment, the second one of the plurality of DC collector voltages is greater than zero and less than the first one of the plurality of DC collector voltages. In the illustrated embodiment, switch 124 sets the DC collector voltage to the first one of the plurality of DC collector voltages when operating in an oil-based mode for removal of oil-based mist, smoke or particles from an air stream, and sets the DC collector voltage to the second one of the plurality of DC collector voltages when operating in a water-soluble mode for removal of water-soluble mist, smoke or particles from an airstream.

In the illustrated embodiment, exhaust fan 126 is driven by an electric motor 128 and is mounted within the housing 102 adjacent to the grill 108. Exhaust fan 126 draws the airstream through electrostatic precipitator cells 114 and 116 from input port 104. Exhaust fan speed controller 130 adjusts a velocity of the airflow through the electrostatic precipitator cells 114 and 116. In one embodiment, the velocity of the airflow is variable up to 850 Cubic Feet per Minute (CFM). In the illustrated embodiment, electrostatic cell test buttons 132 and 134 are located on filter access door 136 for respective electrostatic precipitator cells 114 and 116. Housing 102 also includes an access door interlock switch 138 for access door 136.

During operation of electrostatic precipitation air cleaning system 100, water-soluble mist, smoke or particles or oil-based mist, smoke or particles from an air stream are moved through input port 104 and will pass upwardly through ionizer 114a and collector 114b of electrostatic precipitator cell 114, and will pass through ionizer 116a and collector 116b of electrostatic precipitator cell 116. Respective ionizers 114a and 116a include an ionizer grid that ionizes or charges the mist, smoke or particles. The charged mist, smoke or particles in collectors 114b and 116b will be attracted to ground fins by charged fins that are within each of the respective collectors 114b and 116b.

In the illustrated embodiment, a DC ionizer voltage of 8.75 kV provided at first output 212 of first power supply circuit 210 within high voltage power supply 112 and is supplied to the ionizer grids within ionizer 116a and collector 116b. A switchable DC collector voltage is provided at second output 216 of second power supply circuit 214 within high voltage power supply 112 to the charged fins within collectors 114b and 116b. A DC collector voltage of 4.5 kV is provided at second output 216 when switch 124 in an oil mode or oil-based mode which is when electrostatic precipitation air cleaning system 100 is operated to remove oil-based mist, smoke or particles from an air stream. A DC collector voltage of 2.25 kV is provided at second output 216 when switch 124 in a water mode or water-soluble mode which is when electrostatic precipitation air cleaning system 100 is operated to remove water-soluble mist, smoke or particles from an air stream. In other embodiments, the DC ionizer voltage and the switchable DC collector voltage can have any suitable values.

In the illustrated embodiment, drops of liquid or conductive particles that accumulate within the ionizer grids can potentially arc or short out ionizers 114a and 116a within respective electrostatic precipitator cells 114 and 116 and cause the DC ionizer voltage at first output 212 to drop below an ionizer threshold voltage level. In the illustrated embodiment, the ionizer threshold voltage level is approximately equal to zero volts and occurs when first power supply circuit 210 fails or shuts down. When this occurs, ionizer indicator light 232, which is coupled to first power supply circuit 210, changes from an illuminated state to a non-illuminated state or from the non-illuminated state to the illuminated state to indicate a failure of first power supply circuit 210. In other embodiments, the ionizer indicator light 232 is not used.

In the illustrated embodiment, drops of liquid or conductive particles that accumulate between the charged fins and ground fins can potentially arc or short out collectors 114b and 116b within respective electrostatic precipitator cells 114 and 116 and cause the DC collector voltage at second output 216 to drop below a collector threshold voltage level. In the illustrated embodiment, the collector threshold voltage level is approximately equal to zero volts and occurs when second power supply circuit 214 shuts down. When this occurs, collector indicator light 120, which is coupled to second power supply circuit 214, changes from an illuminated state to a non-illuminated state or from the non-illuminated state to the illuminated state to indicate a failure of second power supply circuit 214.

FIG. 2 illustrates an embodiment of an electrical circuit diagram at 200 for an electrostatic precipitation air cleaning system 100. A male plug 202 is utilized for an electrical connection to a suitable source of electrical power such as 115 VAC at 60 Hz. In other embodiments, other suitable sources of electrical power such as 230 VAC at 60 Hz may be used. In the illustrated embodiment, interlock switch 204 includes a pair of interlocked control switches 206 and 208 which couple the electrical power from plug 202 to speed controller 130 via conductor 218, to high voltage power supply 112 via conductor 220, and to electric motor 128 via conductor 222. Speed controller 130 is coupled to high voltage power supply 112 via conductor 224 and is coupled to electric motor 128 via conductor 226. In one embodiment, speed controller 130 includes a control knob for controlling the speed of electric motor 128 and exhaust fan 126 for controlling the velocity of the airstream produced by exhaust fan 126. In one embodiment, speed controller is a variable potentiometer. In other embodiments, speed controller 130 can be any suitable types of analog or digital motor control devices. Capacitor 228 is coupled between conductor 226 and conductor 230 for providing a smooth start-up operation of electric motor 128.

FIG. 3 illustrates an embodiment of a diagram of a high voltage power supply 112 for an electrostatic precipitation air cleaning system 100. High voltage power supply 112 includes first power supply circuit 210 that generates an ionizer voltage at a first output 212 and a second power supply circuit 214 that generates at least a first collector voltage and a second collector voltage at a second output 216. In the illustrated embodiment, first power supply circuit 210 and second power supply circuit 214 are separate power supply circuits. In another embodiment, first power supply circuit 210 and second power supply circuit 214 are incorporated into a single power supply or power supply circuit that provides both the ionizer voltage at first output 212 and one or more collector voltages at second output 216. In the illustrated embodiment, first power supply circuit 210 includes a first input AC/DC converter or rectifier stage 302 that receives as inputs conductors 220 and 224 (see also, FIG. 2). An output of first AC/DC converter stage 302 at 304 is coupled to a Pulse Width Modulation (PWM) power stage 306. An output of PWM power stage 306 at 308 is coupled to first transformer 310, and an output of first transformer 310 at 312 is coupled to first voltage multiplier 314. An ionizer voltage feedback loop is provided by conductor 316 between first voltage multiplier 314 and PWM power stage 306 to regulate or maintain the ionizer voltage at first output 212 at a DC voltage value. The DC output voltage at first output 212 is regulated to maintain and/or limit an amperage or level of current flow through first output 212 to ionizers 114a and 116a. In the illustrated embodiment, the DC output voltage at first output 212 is maintained at 8.75 kV. In other embodiments, the DC output voltage at first output 212 can be regulated or maintained at other suitable voltage values.

Second power supply circuit 214 includes an input second AC/DC converter or rectifier stage 320 that receives an input via conductor 318 from first transformer 310. An output of second AC/DC converter stage 320 at 324 is coupled to oscillator 326. An output of oscillator 326 at 328 is coupled to second transformer 330, and an output of second transformer 330 at 332 is coupled to second voltage multiplier 334. A collector voltage feedback loop is provided by conductor 336 between voltage multiplier 334 and oscillator 326 to regulate or maintain the DC collector voltage at second output 216 to a desired value. The DC collector voltage at second output 216 is regulated to maintain and/or limit an amperage or level of current flow through second output 216 to collectors 114b and 116b. In the illustrated embodiment, the DC collector voltage provided at second output 216 is regulated at and is switchable between 4.5 kV and 2.25 kV. In other embodiments, the DC output voltage at second output 216 can be regulated or maintained at other suitable voltage values.

In the illustrated embodiment, electrostatic precipitator controller 124 or collector voltage controller 124 is coupled to oscillator 326 of the high voltage power supply 112. Collector voltage controller 124 controls a frequency of oscillator 326 in order to set the DC collector voltage at second output 216 to a desired value. Collector voltage controller 124 can set the DC collector voltage at second output 216 to at least a first collector voltage and a second collector voltage. In some embodiments, collector voltage controller 124 can set the DC collector voltage at second output 216 to a plurality of DC collector voltages that include three or more DC collector voltages. In one embodiment, the second collector voltage is set to a value that is greater than zero and less than the DC output voltage or ionizer voltage at first output 212.

In the illustrated embodiment, collector voltage controller 124 is a collector switch 124 having a first switch state and a second switch state. The first switch state provides a first voltage value via output 338 to oscillator 326 and the second switch state provides a second voltage value via output 338 to oscillator 326. The first voltage value and the second voltage value provided to oscillator 326 control a frequency of oscillator 326 in order to set the collector voltage at second output 216 to a desired value. In one embodiment, the first voltage value is 5 volts and sets the collector voltage at second output 216 to 4.5 kV, and the second voltage value is zero volts and sets the collector voltage at second output 216 to 2.25 kV. In this embodiment, setting the collector voltage at second output 216 to 4.5 kV corresponds to setting switch 124 in an oil mode or oil-based mode when electrostatic precipitation air cleaning system 100 is operated to remove oil-based mist, smoke or particles from an air stream (see also, FIGS. 1a-1b). Setting the collector voltage at second output 216 to 2.25 kV corresponds to setting switch 124 in a water mode or water-based mode when electrostatic precipitation air cleaning system 100 is operated to remove water-soluble mist, smoke or particles from an airstream (see also, FIGS. 1a-1b).

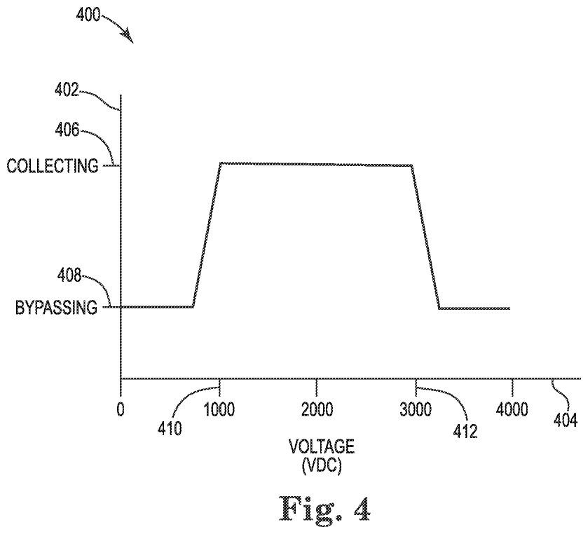

FIG. 4 illustrates an embodiment at 400 of an optimal collector voltage range for a collectors in an electrostatic precipitation air cleaning system 100. The optimal collector voltage range at 400 was determined by performing an experimental test with a MistBuster® 850 compact electrostatic precipitation air cleaning system (model MB850 Compact) manufactured by the assignee of this patent application (see also, FIGS. 1a-1b)

The experiment was performed to determine a collector voltage range that would maximize the ability of the electrostatic precipitator cells 114 and 116 to capture highly conductive mist from a water soluble coolant or fog machine oil. A 1000 watt high output fog machine with a variable mist density control was coupled to input port 104 of housing 102 to direct the conductive mist through collectors 114b and 116b. The fog machine was operated with the electrostatic precipitation air cleaning system 100 running normally until electrostatic precipitator cell 114 was fully saturated and dripping moisture. Once electrostatic precipitator cell 114 was fully saturated, a variable DC voltage power supply was attached to collectors 114b and 116b in order to vary the DC collector voltage provided to collectors 114b and 116b while the DC ionizer voltage applied to ionizers 114a and 116a remained at 8,200 VDC.

The experiment was performed with a bright light positioned to make any bypassed mist flowing out of output port 108 visible, the exhaust fan speed controller 130 of electrostatic precipitation air cleaning system 100 was set at a medium to low setting, and the variable mist density control for the fog machine was set to provide a continuous 50% mist density output into input port 104. The variable DC voltage power supply was adjusted to provide a DC collector voltage to collectors 114b and 116b that ranged between 0 VDC to 4,000 VDC while viewing output port 108 with the bright light.

At low DC collector voltages, the charged mist flowing through collectors 114b and 116b will not be attracted to the ground fins by charged fins that are within collectors 114b and 116b and the mist will be bypassed. At medium DC collector voltages, the charged mist flowing through collectors 114b and 116b will be attracted to the ground fins and collected. At high DC collector voltages, the electrostatic precipitator cells 114 and 116 will noticeably start arcing and shorting out and the mist will bypass electrostatic precipitator cells 114 and 116.

The graph illustrated in FIG. 4 illustrates the status of electrostatic precipitator cells 114 and 116 at 402 as either collecting the mist (at 406) or bypassing the mist (at 408). FIG. 4 further illustrates DC collector voltage values at 404 where the electrostatic precipitator cells 114 and 116 are either collecting mist or bypassing mist. FIG. 4 illustrates electrostatic precipitator cells 114 and 116 are bypassing mist when the collector voltage is below 1,000 VDC as illustrated at 410. When the DC collector voltage is equal to or greater than 3,000 VDC as illustrated at 412, the electrostatic precipitator cells 114 and 116 began to arc and short out and bypass the mist. This experimental test indicates that electrostatic precipitator cells 114 and 116 are effective at capturing a water-soluble chemical such as water soluble machining coolant or fog fluid when the DC collector voltage provided to collectors 114b and 116b is between 1,000 and 3,000 VDC and when the DC ionizer voltage provided to ionizers 114a and 116a is 8,200 VDC.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

The detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in the figures. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. An electrostatic precipitation air cleaning system for removing mist, smoke or particles from an air stream, comprising:
an ionizer;
a collector;
an exhaust fan configured to draw the air stream through the ionizer and the collector;
a high voltage power supply that provides an ionizer voltage to the ionizer and at least a first collector voltage and a second collector voltage; and
an electrostatic precipitator controller coupled to the high voltage power supply and operable to select one of the at least the first collector voltage and the second collector voltage to provide to the collector.

2. The electrostatic precipitation air cleaning system of claim 1, wherein the high voltage power supply comprises a first power supply circuit that generates the ionizer voltage and a second power supply circuit that generates the at least the first collector voltage and the second collector voltage.

3. The electrostatic precipitation air cleaning system of claim 2, wherein the first power supply circuit includes a pulse width modulation circuit, a first transformer and a first voltage multiplier, the first voltage multiplier having a first output that provides the ionizer voltage, and wherein the second power supply circuit includes an oscillator, a second transformer and a second voltage multiplier, the second voltage multiplier having a second output that provides the at least the first collector voltage and the second collector voltage.

4. The electrostatic precipitation air cleaning system of claim 2, wherein the electrostatic precipitator controller comprises a collector voltage controller coupled to the second power supply circuit that is operable to set the at least the first collector voltage and the second collector voltage to a value that is greater than zero and less than the ionizer voltage.

5. The electrostatic precipitation air cleaning system of claim 4, wherein the collector voltage controller is a collector switch having a first switch state and a second switch state, the collector switch operable to provide the first collector voltage to the collector when the collector switch is in the first switch state and to provide the second collector voltage to the collector when the collector switch is in the second switch state, wherein the second collector voltage is greater than zero and is less than the first collector voltage.

6. The electrostatic precipitation air cleaning system of claim 2, further comprising a collector indicator light coupled to the high voltage power supply that changes from an illuminated state to a non-illuminated state or from the non-illuminated state to the illuminated state if the first collector voltage or the second collector voltage falls below a collector voltage threshold level which is approximately equal to zero volts.

7. The electrostatic precipitation air cleaning system of claim 2, further comprising a collector indicator light coupled to the second power supply circuit that changes from an illuminated state to a non-illuminated state or from the non-illuminated state to the illuminated state if the ionizer voltage falls below an ionizer threshold voltage level or if the first collector voltage or the second collector voltage falls below a collector voltage threshold level, wherein the ionizer threshold voltage level and the collector voltage threshold level are approximately equal to zero volts.

8. The electrostatic precipitation air cleaning system of claim 2, further comprising an ionizer indicator light coupled to the high voltage power supply that changes from an illuminated state to a non-illuminated state or from the non-illuminated state to the illuminated state if the ionizer voltage falls below an ionizer threshold voltage level that is approximately equal to zero volts.

9. An electrostatic precipitation air cleaning system for removing water-soluble mist, smoke or particles or oil-based mist, smoke or particles from an air stream, comprising:
a housing that includes a bottom input port and a top output port;
an electrostatic precipitator cell mounted within the housing that includes an ionizer and a collector;
an exhaust fan mounted within the housing between the output port and the electrostatic precipitator cell and operable to draw the airstream through the electrostatic precipitator cell from the input port;
a high voltage power supply that provides a DC ionizer voltage at a first output and a switchable DC collector voltage at a second output; and
a collector voltage controller coupled to the high voltage power supply that is operable to set the switchable DC collector voltage at the second output to at least a first one of a plurality of DC collector voltages and a second one of a plurality of DC collector voltages.

10. The electrostatic precipitation air cleaning system of claim 9, wherein the electrostatic precipitator comprises two or more electrostatic precipitator cells mounted within the housing, each one of the two or more electrostatic precipitator cells including the ionizer and the collector.

11. The electrostatic precipitation air cleaning system of claim 9, wherein the collector voltage controller is a collector switch having a first switch state and a second switch state, the collector switch operable to set the switchable DC collector voltage to the first one of the plurality of DC collector voltages when the collector switch is in the first switch state and set the switchable DC collector voltage to the second one of the plurality of DC collector voltages when the collector switch is in the second switch state, wherein the second one of the plurality of DC collector voltages is greater than zero and less than the first one of the plurality of DC collector voltages.

12. The electrostatic precipitation air cleaning system of claim 9, further comprising a collector indicator light coupled to the high voltage power supply that changes from an illuminated state to a non-illuminated state or from the non-illuminated state to the illuminated state if the switchable DC collector voltage at the second output falls below a collector voltage threshold level.

13. The electrostatic precipitation air cleaning system of claim 9, further comprising a collector indicator light coupled to the second output that changes from an illuminated state to a non-illuminated state or from the non-illuminated state to the illuminated state if the DC ionizer voltage at the first output falls below an ionizer threshold voltage level or if the switchable DC collector voltage at the second output falls below a collector voltage threshold level, wherein the ionizer threshold voltage level and the collector voltage threshold level are approximately equal to zero volts.

14. The electrostatic precipitation air cleaning system of claim 12, wherein the high voltage power supply comprises a first power supply circuit having the first output that provides the DC ionizer voltage and a second power supply circuit having the second output that provides the switchable DC collector voltage.

15. The electrostatic precipitation air cleaning system of claim 14, wherein the first power supply circuit includes a pulse width modulation circuit, a first transformer and a first voltage multiplier, the first voltage multiplier having the first output that provides the DC ionizer voltage, and wherein the second power supply circuit includes an oscillator, a second transformer and a second voltage multiplier, the second voltage multiplier having the second output that provides the switchable DC collector voltage.

16. An electrostatic precipitation air cleaning system for removing water-soluble mist, smoke or particles or oil-based mist, smoke or particles from an air stream, comprising:
a rectangular housing that includes an airstream input port at a bottom of the housing and an airstream output grill at a top of the housing;
a high voltage power supply that provides a DC ionizer voltage at a first output and a switchable DC collector voltage at a second output;
one or more electrostatic precipitator cells mounted within the housing, each electrostatic precipitator cell including an ionizer and a collector, the ionizer coupled to the first output and the collector coupled to the second output;
a collector indicator light coupled to the second output of the high voltage power supply, the collector indicator light changing from an illuminated state to a non-illuminated state or from the non-illuminated state to the illuminated state if the switchable DC collector voltage at the second output falls below a collector voltage threshold level; and
an exhaust fan driven by an electric motor and mounted within the housing adjacent to the output grill and operable to draw the airstream through the one or more electrostatic precipitator cells from the input port.

17. The electrostatic precipitation air cleaning system of claim 16, further comprising a collector voltage controller coupled to the high voltage power supply that is operable to set the switchable DC collector voltage at the second output to a value that is greater than zero and less than the DC ionizer voltage.

18. The electrostatic precipitation air cleaning system of claim 17, wherein the collector voltage controller is a collector switch having a first switch state and a second switch state, the collector switch operable to set the switchable DC collector voltage to a first one of the plurality of DC collector voltages when the collector switch is in the first switch state and set the switchable DC collector voltage to a second one of the plurality of DC collector voltages when the collector switch is in the second switch state, wherein the second one of the plurality of DC collector voltages is greater than zero and less than the first one of the plurality of DC collector voltages.

19. The electrostatic precipitation air cleaning system of claim 16, wherein the high voltage power supply comprises a first power supply circuit having the first output that provides the DC ionizer voltage and a second power supply circuit having the second output that provides the switchable DC collector voltage.

20. The electrostatic precipitation air cleaning system of claim 16, further comprising an ionizer indicator light coupled to the first output that changes from the illuminated state to the non-illuminated state or from the non-illuminated state to the illuminated state if the DC ionizer voltage falls below an ionizer threshold voltage level.

21. The electrostatic precipitation air cleaning system of claim 16, wherein the collector indicator light changes from the illuminated state to the non-illuminated state or from the non-illuminated state to the illuminated state if the DC ionizer voltage at the first output falls below an ionizer threshold voltage level or if the switchable DC collector voltage at the second output falls below a collector voltage threshold level, wherein the ionizer threshold voltage level and the collector voltage threshold level are approximately equal to zero volts.
